(19) United States
(12) Patent Application Publication
(10) Pub. No.: US 2024/0192941 A1
(43) Pub. Date: Jun. 13, 2024

(54) METHOD FOR FIRMWARE BURNING, ELECTRONIC DEVICE, AND NON-TRANSITORY STORAGE MEDIUM

(71) Applicant: Fulian Precision Electronics (Tianjin) Co., LTD., Tianjin (CN)

(72) Inventor: JIE YUAN, Tianjin (CN)

(21) Appl. No.: 18/208,790

(22) Filed: Jun. 12, 2023

(30) Foreign Application Priority Data
Dec. 13, 2022 (CN) 202211603093.8

(51) Int. Cl. G06F 8/61

(52) U.S. Cl. CPC G06F 8/61

(57) ABSTRACT

A method for firmware burning comprises: configuring a RPM SPEC file based on attribute information of a firmware; copying the RPM SPEC file to a first directory of a RPM software directory, and copying a burning tool, and a firmware image file to a second directory of the RPM software directory; generating a firmware installation package based on the first directory, the second directory and a preset RPM product command and installing the firmware installation package based on a preset RPM installation command to burn the firmware. The method can achieve the effect of installation-on-installation burning and avoid the problem of firmware burning failure caused by human misuse of relevant burning documents. An electronic device and a non-transitory storage are also disclosed.

### TECHNICAL FIELD

The subject matter herein generally relates to firmware update.

### BACKGROUND

A firmware is a software embedded in a hardware device, usually located in a special application integrated circuit (ASIC), a flash memory of programmable logic device (PLD), an electrically erasable programmable read-only memory (EERPOM) or a programmable read-only memory (PROM), and the firmware can usually be updated by users.

With a rapid development of technology and user needs related fields, manufactures may improve the performance and reliability of equipment, repair existing program problems or add new functions to the equipment through regular firmware upgrades, so that the equipment can be kept in the best working condition. In the current firmware burning technology, the related files of the firmware are usually stored in a folder to a fixed position, failure of firmware burning may be happen caused by unintentionally changing the location or wrong name of the firmware burning file.

### BRIEF DESCRIPTION OF THE DRAWINGS

Implementations of the present disclosure will now be described, by way of embodiments, with reference to the attached figures.

FIG. 1 is a flowchart of an embodiment of a firmware burning method.

FIG. 2 is a block diagram of an embodiment of a firmware burning system.

FIG. 3 is a block diagram of an embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

A firmware burning method is applied in one or more electronic devices which can compute. The hardware may be but is not limited to Microprogrammed Control Units, Application Specific Integrated Circuits, Field-Programmable Gate Arrays, Digital Signal Processors, and embedded devices, etc.

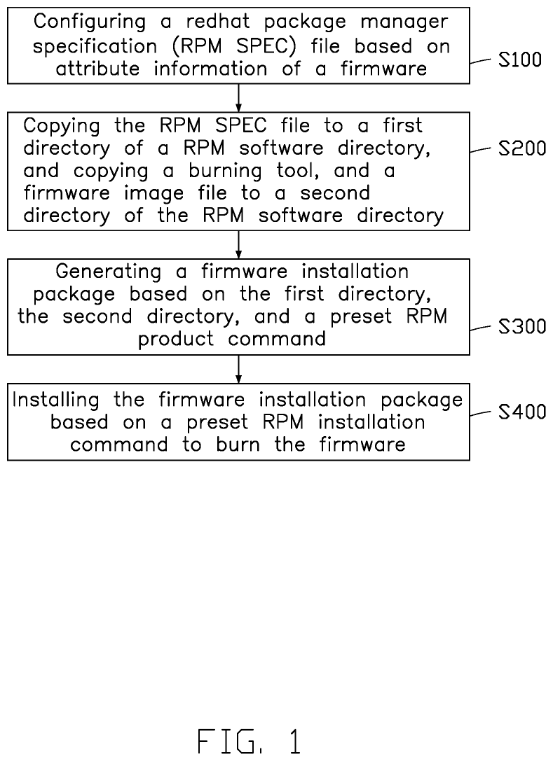

FIG. 1 illustrates one exemplary embodiment of the method. The flowchart presents an exemplary embodiment of the method. The exemplary is provided by way of example, as there are a variety of ways to carry out the method. Each block shown in FIG. 1 may represent one or more processes, methods, or subroutines, carried out in the example method. Furthermore, the illustrated order of block is illustrative only and the order of the blocks can change. Additional blocks can be added or fewer blocks may be utilized, without departing from this disclosure. The example method can be begin at block S100.

In block S100, a redhat package manager specification (RPM SPEC) file is configured based on attribute information of a firmware.

In one embodiment, the redhat package manager (RPM) is a common software package manager based on Redhat, Centos, Fedora and other Linux systems. Users can install a RPM software with only one command, and execute their own scripts in the installation and uninstall stages. The SPEC files are configuration specification files, which is the core of the RPM package compilation process. The SPEC file may record how the package is configured, what patches are made, what files are installed, where to install, and what levels of activities are required during the installation process.

In one embodiment, a header keyword part of the RPM SPEC file, a first execution part association of an installation process of the RPM SPEC file, and a second execution part association of an unloading process of the RPM SPEC file are configured based on the attribute information of the firmware. For example, the RPM SPEC file can include two parts: the header keyword and the execution part of each stage before and after of installation and unloading. Specifically, configuring the header keyword part of the RPM SPEC file based on the attribute information of the firmware comprises following steps: a package name of the firmware installation package is defined through a module field and a version field; a name of the burning tool is defined through a flash tool field; a file name of the firmware image file by a fw_image field, a uefi_bios_image field, and a legacy_bios_image field are defied and a detailed description of the firmware installation package is defined through a description field.

In one embodiment, taking the RPM creation of Host Bus Adapter(HBA) card burning as an example, the configuration of RPM SPEC file is as follows:

%define module LSI9400-8i
%define version 20.00.00.00
%define flash_tool storcli64
%define fw_image 9400-8i.rom
%define uefi_bios_image mpt35sas_x64.rom
%define legacy_bios_image mpt35sas_legacy.rom
%description FW Update for controllers.

In one embodiment, the first execution part association of the installation process of the RPM SPEC file and the second execution part association of the unloading process of the RPM SPEC file are configured based on the attribute information of the firmware that can comprise following steps: an image file to be burned is defined through an install field, and a first script to be executed is defined after the firmware installation package is installed through a post field; a second script to be executed is defined before the firmware installation package is unloaded through a postun field and files comprised in the firmware installation package are defined through a files script. In this embodiment, the contents of the RPM SPEC file are as follows:

```
  %install
  install -m 644 -D $RPM_SOURCE_DIR/%{flash_tool}
$RPM_BUILD_ROOT/tmp/controller/%{flash_tool}
  install -m 644 -D $RPM_SOURCE_DIR/%{fw_image}
$RPM_BUILD_ROOT/tmp/controller/%{fw_image}
  install -m 644 -D $RPM_SOURCE_DIR/%{ uefi_bios_image}
$RPM_BUILD_ROOT/tmp/controller/%{uefi_bios_image}
  install -m 644 -D $RPM_SOURCE_DIR/%{legacy_bios_image}
$RPM_BUILD_ROOT/tmp/controller/%{legacy_bios_image}
  %post
  cd /tmp/controller
  chmod 777 %{flash_tool}
  /%{flash_tool} /c0 download file=%{fw_image}
  /%{flash_tool} /c0 download efibios file=%{uefi_bios_image}
  /%{flash_tool} /c0 download bios file=%{legacy_bios_image}
  %postun
  rm -rf /tmp/controller
  %files
  %defattr(644,root,root,755)
  /tmp/controller/%{flash_tool}
  /tmp/controller/%{fw_image}
  /tmp/controller/%{uefi_bios_image}
  /tmp/controller/%{legacy_bios_image}.
```

In block S200, the RPM SPEC file is copied to a first directory of a RPM software directory, and a burning tool and a firmware image file are copied to a second directory of the RPM software directory.

In one embodiment, taking the RPM software directory of “/root/rpmbuild” as an example, the RPM SPEC file can be copied to a “/root/rpmbuild/SPECS” directory, the “/root/rpmbuild/SPECS” directory is defined as the first directory, a burning tool and a firmware image file are copied to a “/root/rpmbuild/SOURCE” directory, and the “/root/rpmbuild/SOURCE” directory is defined as the second directory. In the subsequent installation and burning process of the firmware installation package, the RPM SPEC files can be read from the first directory, and the burning tool and the firmware image file can be read from the second directory. In other embodies, RPM SPEC files, burning tool and firmware image files can be copied to different directories.

In block S300, a firmware installation package is generated based on the first directory, the second directory, and a preset RPM product command.

In one embodiment, when the preset RPM product command is receiving, the preset RPM product command can be executed to generate the firmware installation package based on the first directory and the second directory. For example, when the firmware burning system received the preset RPM product command, the firmware system can generate a binary firmware upgrade package based on the RPM SPEC files of the first directory, and the burning tool and the firmware image file of the second directory, and the firmware upgrade package is stored in a third directory. In this embodiment, the third directory can be a “/root/rpmbuild/RPMS” directory, this application does not restrict the third directory. The firmware upgrade package can comprise a RPM SPEC file, a burning tool and a firmware image file.

In block S400, the firmware installation package is installed based on a preset RPM installation command to burn the firmware.

In one embodiment, when the firmware burning system receives the preset RPM installation command, the firmware burning system can install the firmware installation package, the burning tool and the firmware image file are decompressed to the specified position(the specified position can be the position that the user sets), the burning tool can execute all the instructions of firmware burning in turn to achieve the effect of firmware burning. In this embodiment, the firmware burning system can read RPM SPEC filed from the first directory, read burning tools and firmware image files from the second directory. It also avoids some problems of the wrong address of RPM SPEC files, the burning tools and the firmware image files and improves the efficiency of burning.

In one embodiment, in the process of firmware burning, the firmware burning system can generate the check code of the firmware installation package based on a cyclic redundancy check (CRC) algorithm, a MD5 Message-Digest (MD5) algorithm or a Secure Hash (SHA1) algorithm. The firmware installation package is checked based on the check code of the firmware installation package to obtain a checking result of a checking process.
the firmware installation package is installed based on the preset RPM installation command if the checking result indicates the checking process is passed; and the firmware installation package is discarded if the checking result indicates the checking process does not pass. For example, in the firmware installation package of the S300 block, the firmware burning system can generate the first check code based on the actual configuration information. Then, the firmware burning system can generate the second check code based on the CRC algorithm, the MD5 algorithm and the SHA1 algorithm. Finally, the firmware burning system will compare whether the first check code and the second check code are consistent before burning and generate the checking result. If the checking result is passed, the firmware installation package can be installed to burn; If the checking result is not passed, the firmware installation package is wrong and discarded.

In one embodiment, the method can customize the SPEC file according to the actual firmware burning requirements, and package the firmware image file, the burin tool and the SPEC file into the RPM firmware installation package. It can realize the effect of installation and burning, and avoid the problem of wrong operation of related burning files. At the same time, the method verifies the consistency of the firmware installation package before completing the final burning work, which further improves the efficiency of burning and avoids the burning failure caused by version number inconsistency or device mismatch between the firmware and the firmware installation package.

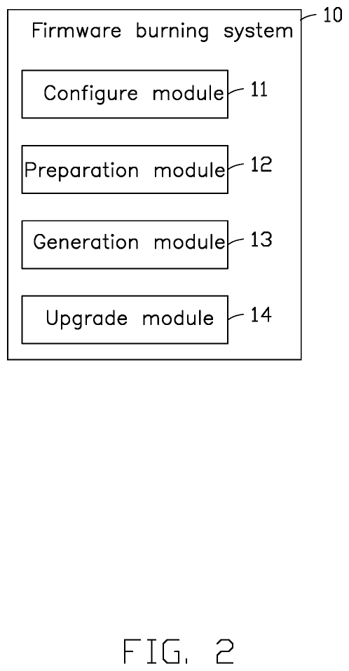

Referring to FIG. 2, the application also provides a firmware burning system 10. The firmware burning system 10 comprises a configure module 11, a preparation module 12, a generation module 13, and a upgrade module 14. Specifically, in one embodiment, the firmware burning system 10 can be applied to electronic devices. The configure module 11 configures a RPM SPECIFICATION (RPM SPEC) file based on attribute information of a firmware; the preparation module 12 copies the RPM SPEC file to a first directory of a RPM software directory, and copying a burning tool, and a firmware image file to a second directory of the RPM software directory; the generation module 13 generates a firmware installation package based on the first directory, the second directory and a preset RPM product command; the upgrade module 14 installs the firmware installation package based on a preset RPM installation command to burn the firmware.

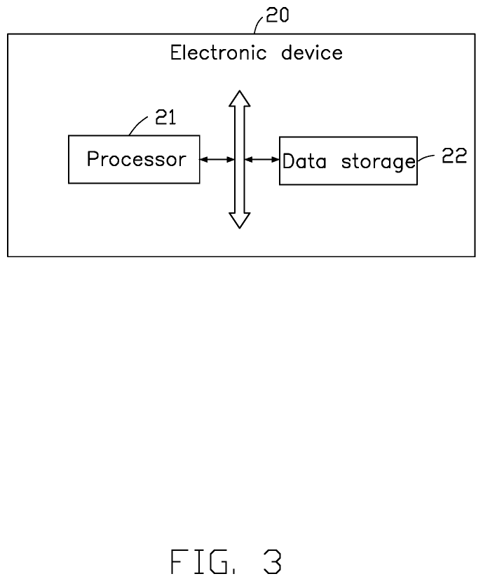

In one embodiment, as shown in FIG. 3, one exemplary embodiment of an electronic device 20 comprises at least one processor 21 and a data storage 22. The data storage 22 stores one or more programs which can be executed by the at least one processor 21. The data storage 22 is used to store instructions, and the processor 21 is used to call up instructions from the data storage 22, so that the electronic device 20 performs the steps of the firmware burning method in the above embodiment. The electronic devices 20 can be desktop computers, laptops, handheld computers, cloud servers and other computing devices. The electronic devices 20 can interact with users through keyboard, mouse, remote control, touchpad or voice control devices.

In one embodiment, a non-transitory storage medium recording instructions is disclosed. When the recorded computer instructions are executed by a processor of an electronic device 20, the electronic device 20 can perform the method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A firmware burning method, comprising:
configuring a redhat package manager specification (RPM SPEC) file based on attribute information of a firmware;
copying the RPM SPEC file to a first directory of a RPM software directory, and copying a burning tool and a firmware image file to a second directory of the RPM software directory;
generating a firmware installation package based on the first directory, the second directory, and a preset RPM product command; and
installing the firmware installation package based on a preset RPM installation command to burn the firmware.

2. The firmware burning method of claim 1, wherein configuring the RPM SPEC file based on the attribute information of the firmware further comprises:
configuring a header keyword part of the RPM SPEC file based on the attribute information of the firmware, and configuring a first execution part association of an installation process of the RPM SPEC file and a second execution part association of an unloading process of the RPM SPEC file based on the attribute information of the firmware.

3. The firmware burning method of claim 2, wherein configuring the header keyword part of the RPM SPEC file based on the attribute information of the firmware further comprises:
defining a package name of the firmware installation package through a module field and a version field;
defining a name of the burning tool through a flash tool field;
defining a file name of the firmware image file by a fw_image field, a uefi_bios_image field, and a legacy_bios_image field; and
defining a detailed description of the firmware installation package through a description field.

4. The firmware burning method of claim 2, wherein configuring the first execution part association of the installation process of the RPM SPEC file and the second execution part association of the unloading process of the RPM SPEC file based on the attribute information of the firmware further comprises:
defining an image file to be burned through an install field, and defining a first script to be executed after the firmware installation package is installed through a post field; and
defining a second script to be executed before the firmware installation package is unloaded through a postun field and defining files comprised in the firmware installation package through a files script.

5. The firmware burning method of claim 1, wherein generating the firmware installation package based on the first directory, the second directory, and the preset RPM product command further comprises:
receiving the preset RPM product command; and
executing the preset RPM product command to generate the firmware installation package based on the first directory and the second directory.

6. The firmware burning method of claim 5, further comprising:
generating a check code of the firmware installation package based on a cyclic redundancy check (CRC) algorithm, a MD5 Message-Digest (MD5) algorithm, or a Secure Hash (SHA1) algorithm.

7. The firmware burning method of claim 6, wherein installing the firmware installation package based on the preset RPM installation command comprising:
checking the firmware installation package based on the check code of the firmware installation package to get a checking result of a checking process;
installing the firmware installation package based on the preset RPM installation command, if the checking result indicates the checking process is passed; and
discarding the firmware installation package if the checking result indicates the checking process does not pass.

8. An electronic device, comprising:
at least one processor; and
a data storage storing one or more programs which when executed by the at least one processor, cause the at least one processor to execute following actions:
configuring a redhat package manager specification (RPM SPEC) file based on attribute information of a firmware;
copying the RPM SPEC file to a first directory of a RPM software directory, and copying a burning tool and a firmware image file to a second directory of the RPM software directory;
generating a firmware installation package based on the first directory, the second directory and a preset RPM product command; and
installing the firmware installation package based on a preset RPM installation command to burn the firmware.

9. The electronic device of claim 8, wherein configuring the RPM SPEC file based on the attribute information of the firmware further comprises:
configuring a header keyword part of the RPM SPEC file based on the attribute information of the firmware, and configuring a first execution part association of an installation process of the RPM SPEC file and a second execution part association of an unloading process of the RPM SPEC file based on the attribute information of the firmware.

10. The electronic device of claim 9, wherein configuring the header keyword part of the RPM SPEC file based on the attribute information of the firmware further comprises:
defining a package name of the firmware installation package through a module field and a version field;
defining a name of the burning tool through a flash tool field;
defining a file name of the firmware image file by a fw_image field, a uefi_bios_image field, and a legacy_bios_image field; and
defining a detailed description of the firmware installation package through a description field.

11. The electronic device of claim 9, wherein configuring the first execution part association of the installation process of the RPM SPEC file and the second execution part association of the unloading process of the RPM SPEC file based on the attribute information of the firmware further comprises:
defining an image file to be burned through an install field, and defining a first script to be executed after the firmware installation package is installed through a post field; and
defining a second script to be executed before the firmware installation package is unloaded through a postun field and defining files comprised in the firmware installation package through a files script.

12. The electronic device of claim 8, wherein generating the firmware installation package based on the first directory, the second directory, and the preset RPM product command further comprises:
receiving the preset RPM product command; and
executing the preset RPM product command to generate the firmware installation package based on the first directory and the second directory.

13. The electronic device of claim 12, wherein the at least one processor is further configured to:
generate a check code of the firmware installation package based on a cyclic redundancy check (CRC) algorithm, a MD5 Message-Digest (MD5) algorithm or a Secure Hash (SHA1) algorithm.

14. The electronic device of claim 13, wherein installing the firmware installation package based on the preset RPM installation command further comprising:
checking the firmware installation package based on the check code of the firmware installation package to get a checking result of a checking process;
installing the firmware installation package based on the preset RPM installation command, if the checking result indicates the checking proces is passed; and
discarding the firmware installation package if the checking result indicates the checking process does not pass.

15. A non-transitory storage medium having stored thereon instructions that, when executed by a processor of an electronic device, causes the electronic device to perform a firmware burning method, the firmware burning method comprising:
configuring a redhat package manager specification (RPM SPEC) file based on attribute information of a firmware;
copying the RPM SPEC file to a first directory of a RPM software directory, and copying a burning tool and a firmware image file to a second directory of the RPM software directory;
generating a firmware installation package based on the first directory, the second directory and a preset RPM product command; and
installing the firmware installation package based on a preset RPM installation command to burn the firmware.
